(19) United States
(12) Patent Application Publication
(10) Pub. No.: US 2026/0111360 A1
(43) Pub. Date: Apr. 23, 2026

(54) PERIPHERAL COMPONENT INTERCONNECT EXPRESS BUS UNIT (PBU)-TO-NEST DIRECTED OPERATIONS

(71) Applicant: International Business Machines Corporation, Armonk, NY (US)

(72) Inventors: Craig R. WALTERS, Highland, NY (US); Yamil A. RIVERA, Peekskill, NY (US); Matthias KLEIN, Poughkeepsie, NY (US); Michael James BECHT, Poughkeepsie, NY (US)

(21) Appl. No.: 18/923,325

(22) Filed: Oct. 22, 2024

(51) Int. Cl. G06F 12/02; G06F 11/07; G06F 13/16

(52) U.S. Cl. CPC G06F 12/0292; G06F 11/0778; G06F 12/0246; G06F 13/1673

(57) ABSTRACT

Method and apparatus for memory location prediction in a distributed memory system are provided. A memory access request is received from a requesting device, the memory access request comprising a target address. A tracking table is checked to determine that data corresponding to the target address is stored in a remote memory, where the remote memory comprises one or more memory modules. In response to the determination, a search is initiated in the remote memory to identify a memory module that contains the data corresponding to the target address prior to completing a search in a local memory. The identified data is received from the identified memory module in the remote memory. The tracking table is updated with an entry corresponding to the target address.

### BACKGROUND

The present disclosure relates to access management in distributed memory systems, and more specifically, to predicting memory locations using a tracking table to manage peripheral component interconnect express (PCIe) bus unit (PBU)-to-nest directed operations.

### SUMMARY

One embodiment presented in this disclosure provides a method, including receiving a memory access request from a requesting device, the memory access request comprising a target address, determining that data corresponding to the target address is stored in a remote memory by checking a tracking table, where the remote memory comprises one or more memory modules, in response to the determination, initiating a search in the remote memory to identify a memory module that contains the data corresponding to the target address, wherein the search in the remote memory is performed prior to completing a search in a local memory, receiving the data corresponding to the target address from the identified memory module in the remote memory, and updating the tracking table with an entry corresponding to the target address.

Other embodiments in this disclosure provide non-transitory computer-readable media containing computer program code that, when executed by operation of a computer system, performs operations in accordance with one or more of the above methods, as well as systems comprising one or more memories collectively containing one or more programs, and one or more processors, wherein the one or more processors are configured to, individually or collectively, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example nest structure with multiple drawers connected through interconnects, according to some embodiments of the present disclosure.

FIG. 3 depicts an example workflow for cross-drawer data retrieval, according to some embodiments of the present disclosure.

FIG. 4 depicts an example tracking table, according to some embodiments of the present disclosure.

FIG. 5 depicts an example method for handling local and remote data requests by a PBU, according to some embodiments of the present disclosure.

FIG. 6 depicts an example method of data retrieval by a PBU in a remote drawer after receiving a PCIe request from a remote drawer, according to some embodiments of the present disclosure.

FIG. 7 depicts an example method for generating and updating a tracking table with static and dynamic data, according to some embodiments of the present disclosure.

FIG. 8 is a flow diagram depicting an example method for data retrieval and table update, according to some embodiments of the present disclosure.

FIG. 9 depicts an example PBU configured to perform various aspects of the present disclosure, according to some embodiments of the present disclosure.

### DETAILED DESCRIPTION

In computing systems with distributed memory or multi-drawer setups, the PBU manages memory and input/output (I/O) access between the requesting device and memory module to ensure efficient data retrieval operations across local and remote memory locations. Conventionally, PBU-to-nest accesses follow a process fetch flow to locate and retrieve the target data. More specifically, the PBU first searches the target address within the local drawer. If the data is not found locally, the PBU then escalates the request to access remote memory located in a different drawer, connected via a high-speed interconnect. While this process fetch flow helps to optimize local access, it introduces significant overhead when the data is located in a remote drawer. The PBU must first perform a local search, even if the data is unlikely to be found locally. This extra search step adds unnecessary latency, which, when accumulated, can lead to performance degradation, particularly in workloads with frequent cross-drawer memory accesses. However, given that I/O operations are often highly sequential in nature, there is potential for these access patterns to be predicted before the search is initiated.

The present disclosure introduces techniques to predict data location for an I/O memory access request, allowing the PBU to make informed decisions about whether to search locally or bypass this step. In some embodiments, the prediction may be made using a tracking table, which is constructed based on defined static configuration and historical access patterns and/or dynamically updated as new I/O requests are being processed. By checking the tracking table, the PBU may bypass the initial local search step when the data is predicted to reside in a remote memory or drawer. The disclosed mechanism reduces overhead and improves overall efficiency for systems with frequent cross-drawer memory accesses.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

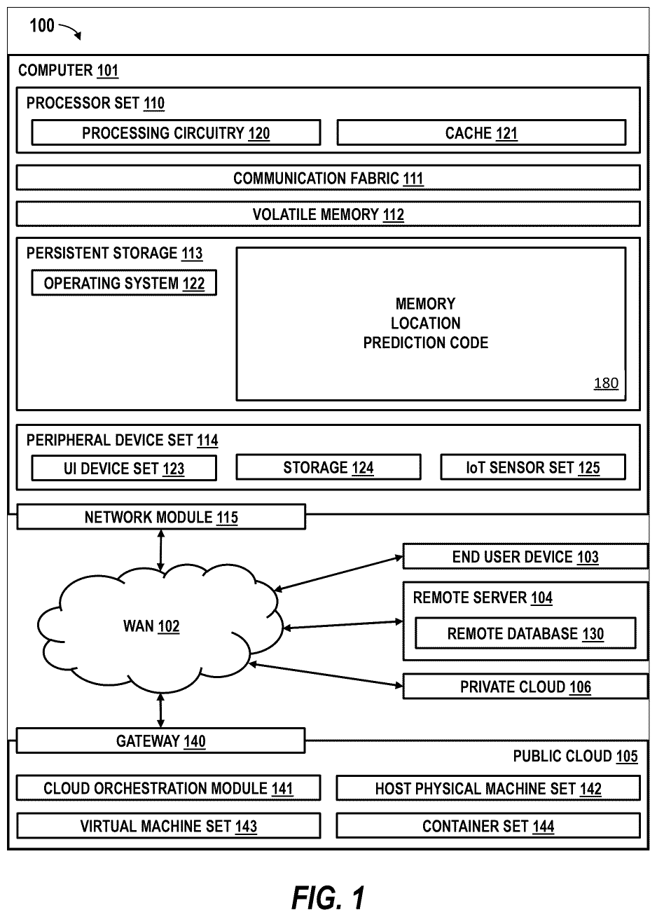

FIG. 1 depicts an example computing environment for the execution of at least some of the computer code involved in performing the inventive methods.

Computing environment 100 contains an example of an environment for the execution of at least some of the computer code involved in performing the inventive methods, such as Memory Location Prediction Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Memory Location Prediction Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Memory Location Prediction Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Memory Location Prediction Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

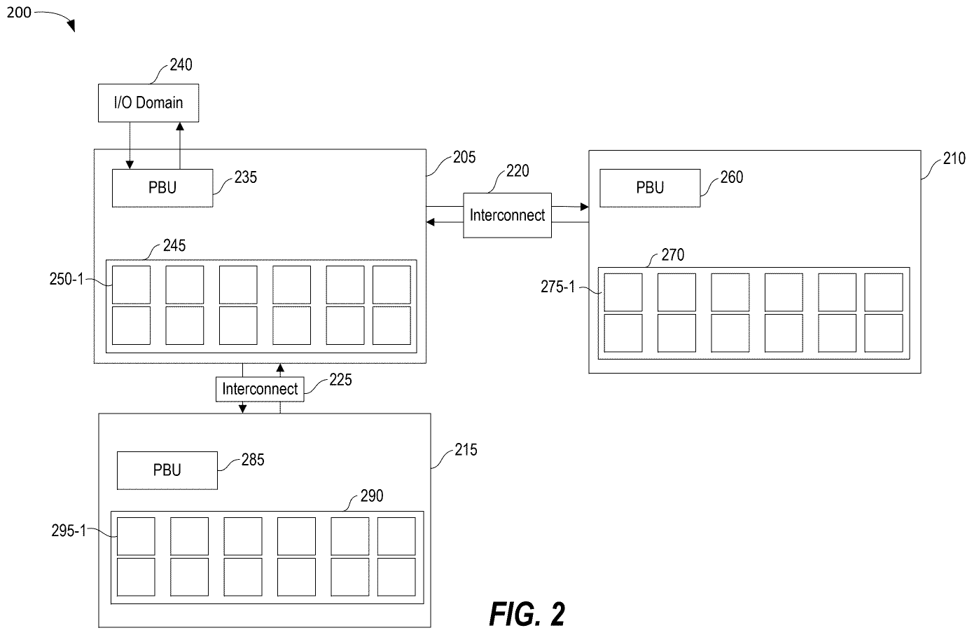

FIG. 2 depicts an example nest structure 200 with multiple drawers 205, 210, and 215 connected through interconnects 220 and 225, according to some embodiments of the present disclosure.

As depicted, the example nest structure 200 includes three drawers 205, 210, and 215. As used herein, the drawer refers to a physical enclosure that houses various processing and memory components. As used herein, the nest structure 200 refers to a distributed memory system that consists of multiple drawers, each connected to form a network that allows for efficient data retrieval and cross-drawer communication. The depicted example nest structure 200, comprising three drawers, is provided for conceptual clarity. In some embodiments, the nest may include any number of drawers, depending on system requirements and scalability needs.

As depicted, each drawer includes a PBU and a memory array. Drawer 205 contains PBU 235 and memory array 245. Drawer 210 contains the PBU 260 and memory array 270. Drawer 215 contains PBU 285 and memory array 290. The depicted drawers are provided for conceptual clarity. In some embodiments, each drawer may include any number of PBUs, memory arrays, and other processing and memory components (e.g., CPU, DMA controller, or any other specialized hardware).

As depicted, each memory array (e.g., 245, 270, or 290) includes multiple memory modules (e.g., 250-1, 275-1, or 295-1). Each memory module may store data in a predefined page size, such as 4 KB or 1 MB. These memory modules may be accessed either locally by the CPU or other components (e.g., I/O devices) located within the same drawer, or remotely by devices in other drawers within the nest system.

As depicted, the drawer 205 connects to one or more I/O domains 240. As used herein, I/O domain 240 may refer to a device or subsystem that sends I/O requests to the drawer it is directly connected to. These requests may include operations such as reading data from the drawer it is directly connected to or from a remote drawer within the nest, or writing data to the local drawer or to other drawers in the nest system. In some embodiments, the I/O domain 240 may be physically located within the same drawer as the PBU 235 or external to it, connected via an interconnect or bus.

In some embodiments, the PBU (e.g., 235, 260, or 285) may correspond to an I/O controller or I/O subsystem, configured to handle different types of memory access requests received from the I/O domain 240, such as reading or writing data from local or remote memory, and facilitate cross-drawer communication through the interconnects. The PBU may also be referred to as peripheral component interconnect express (PCIe) bus interface and may include various types of computing devices, such as a processor, an Artificial Intelligence Unit (AIU), a Neural Processing Unit (NPU), or other specialized hardware.

As depicted, drawers 205 and 210 are connected via an interconnect 220, and drawers 205 and 215 are connected via an interconnect 225. In some embodiments, drawers 210 and 215 may be connected via another interconnect (not shown). These interconnects serve as high-speed data links, which allow drawers to communicate with each other and facilitate remote memory access and data sharing across the nest system. In some embodiments, the interconnects 220 and 225 may be established using protocols like PCIe or other high-performance interconnect technologies.

When the I/O domain 240 intends to access memory pages stored in local or remote drawers, in some embodiments, the I/O domain 240 may first send an I/O request to the PBU 235. The request may include a target address for the data being requested. In a conventional approach, PBU 235 may first search for the target address in the local memory array 245. If the data is not found locally, the PBU 235 may then initiate a search in remote memory, which may involve sending requests to other drawers (e.g., 210 or 215). This sequential search process may introduce overhead and delay, especially when accessing data stored remotely, as it requires the PBU 235 to first exhaust local search efforts before expanding to remote drawers.

In embodiments of the present disclosure, the PBU 235 may first determine whether the address is located locally or remotely by consulting a tracking table. In some embodiments, the tracking table may store data location information based on predefined static configurations and historical memory access patterns. If the data is determined to be saved in the local memory array 245, the PBU 235 may access the data directly using a local memory access request. If the data is determined to not be saved in the local memory array 245, the PBU 235 may a request (e.g., PCIe request) through the interconnect (e.g., 220 or 225) to access the data in a remote drawer (e.g., 210 or 215) prior to performing a local search. Such an approach may streamline cross-drawer communication and reduce latency as it avoids unnecessary local memory searches.

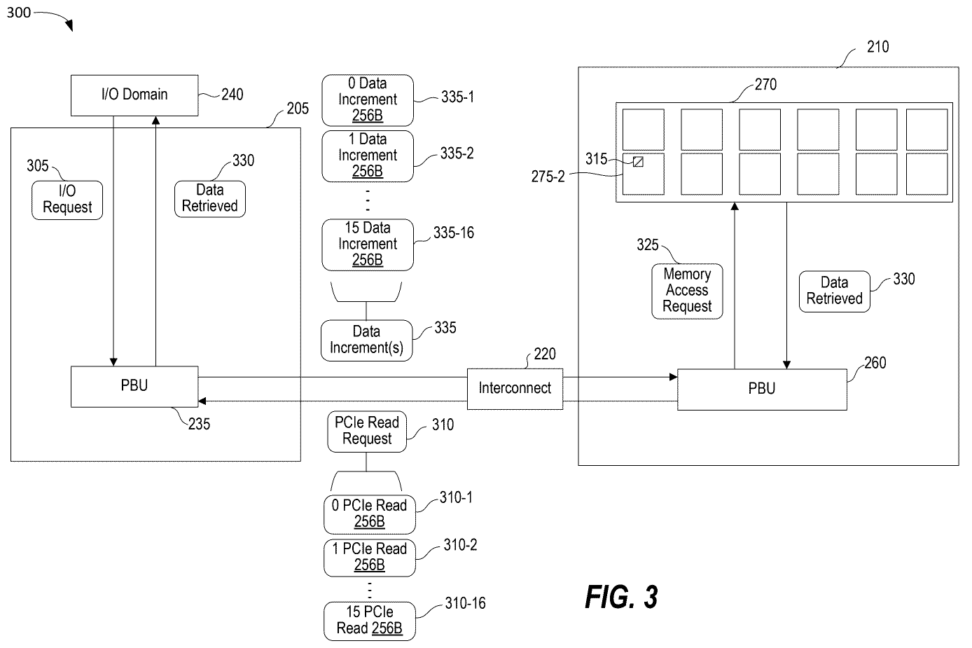

FIG. 3 depicts an example workflow 300 for cross-drawer data retrieval, according to some embodiments of the present disclosure.

As depicted, the I/O domain 240 connects to drawer 205 and generates an I/O request 305 to access data stored either in the local memory array (e.g., 245 of FIG. 2) or a remote memory array (e.g., 270 or 295 of FIG. 2). In some embodiments, the I/O request 305 may either be a read or a write request. An I/O read request may include the target address for the data being requested, and an I/O write request may include the target address where new data will be written. In the depicted workflow 300, the I/O request 305 is a read request.

The I/O domain 230 sends the I/O read request 305 to the PBU 235 located in drawer 205. Upon receiving the request, the PBU 235 analyzes the target address to determine whether the being requested is stored in the local memory array (e.g., 245 of FIG. 2) or in a remote memory array 270 (within a remote drawer 210). The PBU 235 may use a tracking table to make this determination. As discussed above, the tracking table may include data location information based on predefined static configurations and historical memory access patterns. By determining whether the target address falls within an entry of the tracking table, the PBU 235 may identify whether the data being requested is stored in the local memory or remote drawer.

In the depicted workflow 300, the data is determined to be in the remote drawer 210. Based on the determination, the PBU 235 generates a PCIe read request 310 for the remote drawer 210 prior to completing a local search. In some embodiments, the PCI request may include information such as the target address, the size of the data to be retrieved (e.g., 4 KB), and the type of the request (e.g., read or write). In embodiments where the data being requested is large, such as 4 KB, but the interconnect between drawers only allows smaller data payloads, such as 256 bytes, the PBU 235 may generate multiple PCIe requests (e.g., 310-1, 310-2, 310-16) and send them sequentially to retrieve the entire data. For example, in some embodiments, the PBU 235 may generate 16 separate PCIe requests (e.g., 310-1, 310-2, 310-16) to fetch the full 4 KB of data.

The PBU 235 then sends the PCIe request 310 to the drawer 210 via the high-speed interconnect 220. In embodiments where the tracking table indicates that the data is in a remote drawer without specifying which target drawer, the PBU 235 may send the PCIe request 310 to every other connected drawer (e.g., 210 or 215 of FIG. 2).

In embodiments where the data is determined to be saved locally, the PBU 235 may check the address range to locate the memory module (e.g., 250-1 of FIG. 2) containing the requested data. Once the memory module is identified, the PBU 235 may generate a local memory access request to retrieve the data directly from the local memory.

As depicted, the PBU 260 receives the PCIe request 310 and processes the target address provided in the request 310 to determine the exact memory location where the requested data is stored.

As illustrated, based on the target address, the PBU 260 in drawer 210 identifies that the requested data block 315 is 4 KB in size and stored in memory module 275-2. The PBU 260 retrieves the data 330 from the memory module 275-2 via a local memory access request 325, and prepares to send the data back to drawer 205. As depicted, the retrieved 4 KB data block 330 is segmented into smaller data increments 335 (e.g., 256 bytes each) to comply with the transfer protocol (e.g., PCIe) and accommodate hardware limitations. The PBU 260 then transmits the data increments 335 over the interconnect 220 back to drawer 205. The PBU 235 receives the data increments 335 and passes them sequentially to the PBU 235. As depicted, 16 increments in total are forwarded to the PBU 235, where “0 Data Increment 256B” 335-1 represents the first increment, “1 Data Increment 256B” 335-2 represents the second increment, and “15 Data Increment 256B” 335-16 represents the last increment.

The PBU 235 in drawer 205 reassembles the data increments 335 into a full 4 KB data block 330, buffers the data if necessary, and forwards the complete data block 330 to the requesting device, which is the I/O domain 240. By having the PBU 235 in drawer 205 perform the check to determine whether the data is local or remote and conduct a remote search prior to completing a local search when appropriate, the example workflow 300 reduces latency and improves the overall efficiency for the PBU-to-nest access process, especially for cross-drawer communication.

The example workflow 300 is provided for conceptual clarity. Each drawer in the distributed memory system may connect to one or more I/O domains. Each I/O domain 240 connecting to the drawer 205 may send I/O requests to the PBU (e.g., 235) for data access or retrieval, similar to the process as depicted in the example workflow 300.

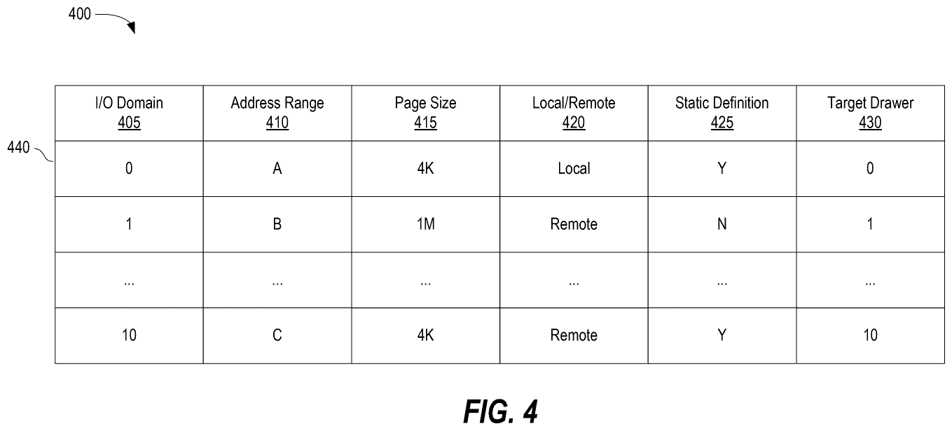

FIG. 4 depicts an example tracking table 400, according to some embodiments of the present disclosure. The example tracking table 400 includes five columns, each representing different aspects of memory management and access. Column 405 indicates the I/O domain that sends the I/O request (read or write). Column 410 indicates the address range, representing the memory addresses managed by the I/O domain. Column 415 indicates the page size, such as 4 KB or 1 MB defining the size of data blocks being managed in memory modules (e.g., 250-1 of FIG. 2). Column 420 provides whether the data is stored locally or remotely. Column 425 indicates the static definition, specifying whether the address space allocation is static or subject to change. Column 430 provides the target drawer, indicating where the data is physically stored (either in a local drawer or a remote one).

The example tracking table 400 includes multiple entries 440, each corresponding to different memory regions and I/O domains. In some embodiments, entries 440 in the table 400 may be statically defined during system initialization based on known memory configurations and predefined address ranges. For example, when the nest system (or distributed memory system) has address space statically allocated during the initial machine load (IML) process, entries in the tracking table may be prepopulated to reduce overhead during runtime. These static allocated addresses may include host system address (HSA), coupling address, system access point (SAP) address, and the like.

In some embodiments, the entries 440 may be dynamically updated as the PBU (e.g., 235 of FIG. 3) processes I/O requests (e.g., 305 of FIG. 3). When the PBU receives a memory access request for a target address not already in the table, the PBU may add an entry based on the information gathered from processing the request. For example, if the PBU retrieves data from memory modules residing in a remote drawer (e.g., drawer 3) (not shown in the existing table), the PBU may update the table with a new entry indicating the I/O domain, address range, and page size associated with the memory module. The new entry may be marked as remote, with no static definition (if the data location changes over time), and drawer 3 may be set as the target drawer. The dynamic updates allow the PBU to optimize future access to memory addresses within the same range.

In some embodiments, the tracking table may be updated upon the determination that an access request has been successfully resolved. The determination may rely on source codepoints or handshakes returned from the nest system (e.g., PBUs in remote drawers).

In some embodiments, address space may be traced based on a target 4 KB or 1 MB page after calculating the zone-absolute address, which identifies the memory location across the distributed system. The size of the address range tracking column 410 in the table may be flexible or configurable, allowing for adjustments based on system needs, such as tracking different page sizes or a broader address range.

In some embodiments, the tracking table 400 may only monitor access requests resolved locally or those resolved remotely. For example, if the table 400 only tracks local access requests, any request not resolved locally may be inferred to involve remote memory access. If the table 400 only tracks remote access requests, any request not resolved remotely may be inferred to involve local memory access. This approach allows the PBU to reduce the number of entries in its tracking table while still effectively predicts access to either local or remote memory.

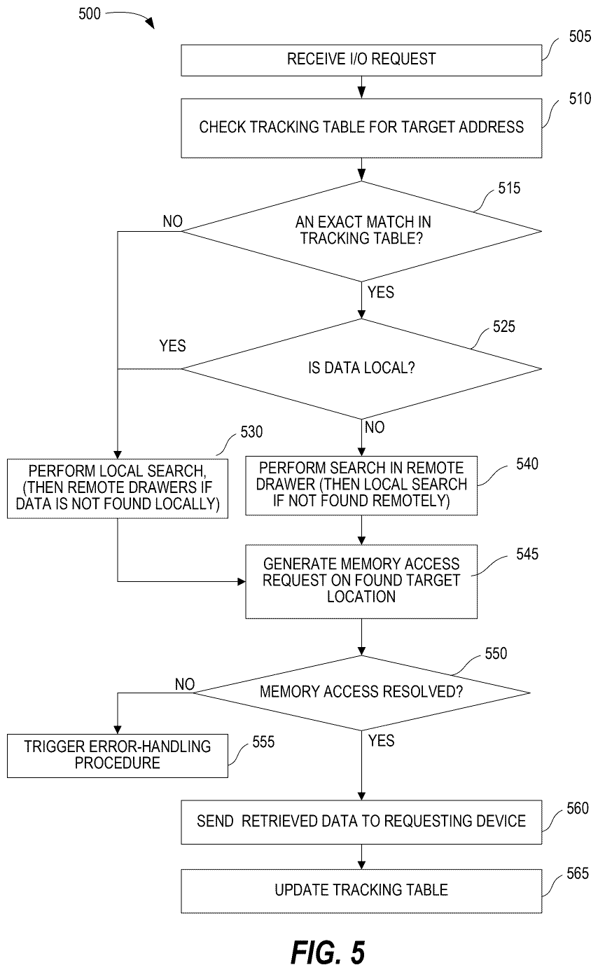

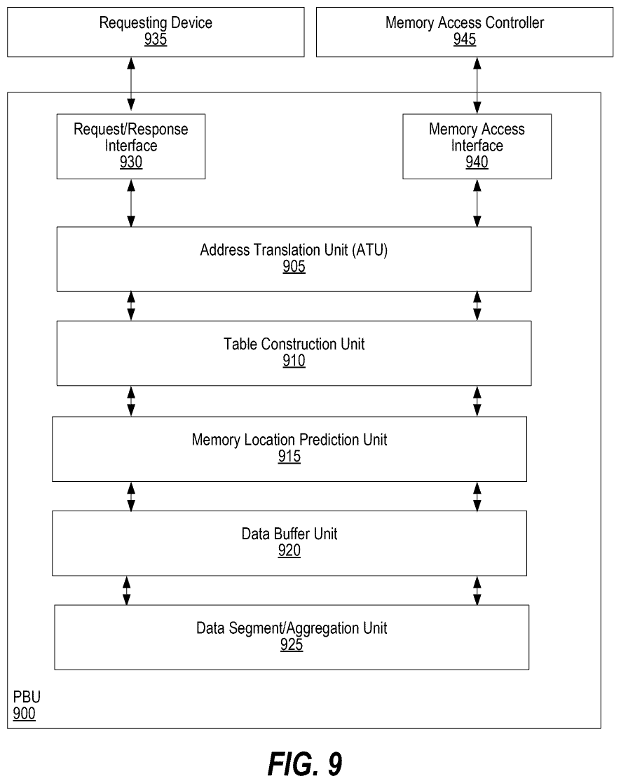

FIG. 5 depicts an example method 500 for handling local and remote data requests by a PBU, according to some embodiments of the present disclosure. In some embodiments, the PBU may be one or more computer devices or systems configured to manage memory access requests, such as the computer 101 as illustrated in FIG. 1, the PBUs 235, 260, and 285 as illustrated in FIG. 2, the PBUs 235 and 260 as illustrated in FIG. 3, or the PBU 900 as illustrated in FIG. 9.

At block 505, a PBU (e.g., 235 of FIG. 3) receives an I/O request (e.g., 305 of FIG. 3) from a requesting device (e.g., I/O domain 240 of FIG. 3), where the requesting device connects to the drawer where the PBU is located. In some embodiments, the I/O request may include details such as the target address and/or the type of the request (write or read).

At block 510, the PBU checks the tracking table (e.g., 400 of FIG. 4) for the target address. For read requests, the PBU checks the tracking table to determine whether the requested data is stored in the local memory (e.g., within the same drawer as the PBU) or in a remote memory (e.g., located in a different drawer from the PBU). For write requests, the PBU checks the tracking table to determine whether the data should be saved in local or remote memory. In some embodiments, the tracking table in the PBU may be generated based on a combination of predefined static configuration (e.g., during the initialization) and dynamic updates as the PBU processes I/O requests.

At block 515, the PBU determines whether there is an exact match for the target address in the tracking table. As used herein, an exact match for the target address may refer to the situation where the target address falls within a specific address range (e.g., column 410 for “Address Range” of FIG. 4) listed in the table, along with the corresponding I/O domain, page size, target drawer, and other relevant parameters. If an exact match is found, the method proceeds to block 525, where the PBU identifies the data location (local or remote) based on the entry in the table (e.g., column 430 for “Target Drawer” of FIG. 4). If the PBU does not find any entry in the tracking table that corresponds to the target address, the method 500 proceeds to block 530.

At block 525, after finding an exact match in the table, the PBU determines whether the data is saved in the local memory. This may be determined by examining the “Target Drawer” column (e.g., 430 of FIG. 4) in the tracking table. If the PBU determines that the data is saved locally (e.g., the “Target Drawer” shows “0”), such as the target address corresponds to a memory location within the same drawer as the PBU, the method 500 moves to block 530. If it is determined that the data is saved remotely (e.g., the “Target Drawer” shows “1”), indicating that the target address corresponds to a memory location within a different drawer from the PBU, the method 500 moves to block 540.

At block 530, the PBU follows a conventional approach by performing a local search within the same drawer to identify the memory module that might store the requested data. This may involve checking the address range and page size within the local memory to locate the appropriate storage location. When the data is found locally, the PBU may generate a local memory access request to retrieve the data from the memory module in the local memory array. In embodiments where the I/O request is a write request, the PBU may first identify the memory module in the local memory array where the new data should be written. Upon identification, the PBU may generate a local memory write request and perform the write operation to store the new data to the target address in the identified memory module.

When the data is not found locally at block 530, the PBU then initiates a remote search. In embodiments where the tracking table has an entry indicating that the data is saved in local memory (at block 525), the local search may still fail, possibly due to stale or incorrect information in the table. In this configuration, the tracking table may be updated after determining the correct data location. Upon determining the location of the data in the remote drawer, the PUB, at block 545, generates and sends memory access requests through the interconnects to retrieve the data from the remote drawer module. The method 500 then moves to block 550, where the PBU continues to monitor whether the data has been resolved. More specifically, the PBU monitors whether the data has been successfully fetched (for a read request) or written (for a write request).

As discussed above, if the tracking table indicates that the data is saved remotely (at block 525), the method 500 moves to block 540, where the PBU performs a remote search before conducting a local search. If the data is found in a remote memory module, the method 500 moves to block 545, where the PBU generates and sends memory access requests to retrieve the data from the remote module. However, if the data is not found in the remote module (even though the table suggests it is saved remotely, possibly due to stale or incorrect information), a local search is then performed.

In embodiments where the tracking table indicates a target drawer for the requested address, the PBU may send the PCIe request specifically to that drawer, which reduces unnecessary traffic to other drawers. However, if the tracking table does not specify the target drawer (e.g., only indicating it is remote or not), the PCIe request may be sent to all connected drawers. Once the request reaches the remote drawer, the PBU (e.g., 260 of FIG. 3) in that drawer may identify the memory module (e.g., 275-2 of FIG. 3) that stores the data being requested based on the target address. The PBU in the remote drawer may then retrieve the data (e.g., 330 of FIG. 3) from the identified memory module, segment the data into smaller increments (e.g., 256 bytes each) (e.g., 335 of FIG. 3) for transmission over the interconnect (e.g., 220 of FIG. 3), and send the data increments back to the requesting PBU.

In embodiments where the I/O request is a write request, the PBU may generate one or more PCIe write requests to send new data to a remote drawer where the new data should be stored. The PBU may segment the new data into smaller increments for transmission over the interconnect. The PBU in the remote drawer may process the PCIe write requests by identifying the memory module where the data should be written, and receiving and storing the new data in the identified memory module.

At block 550, the PBU determines whether the memory access request (also referred to in some embodiments as the I/O request) has been resolved. For a read request, the resolution of the request may refer to that the data has been successfully received from either the local or remote memory. For a write request, the resolution of the request may refer to that the new data has been successfully stored in either local or remote memory. In some embodiments, the determination may be based on source codepoints or handshake signals returned from the remote drawer's PUB or memory controller, confirming the completion of the memory access operations (e.g., data retrieved or written).

If the request is unresolved, the method 500 proceeds to block 555, where the PBU triggers an error handling mechanism, which may include retrying the data request or write operations, reporting the error to the requesting device (e.g., I/O domain 240 of FIG. 3), and/or logging the error into a diagnostic log for further analysis.

If the request is resolved, the method 500 proceeds to block 560, where the PBU sends the data to the requesting device (e.g., I/O domain 240 of FIG. 3). In embodiments where the data is received in increments, the PBU may buffer the data increments and reassemble them into a full block (e.g., 4 KB) before proceeding to send the reassembled data to the requesting device. At block 565, the PBU updates the tracking table to ensure that the target address (within the current I/O request) and the accessed memory are correctly reflected.

In embodiments where the I/O request is a write request, the operations at blocks 560 and 565 may be skipped. Instead, the PBU may receive and buffer, if necessary, the new data from the requesting device, and send the data to either local or remote memory for storage.

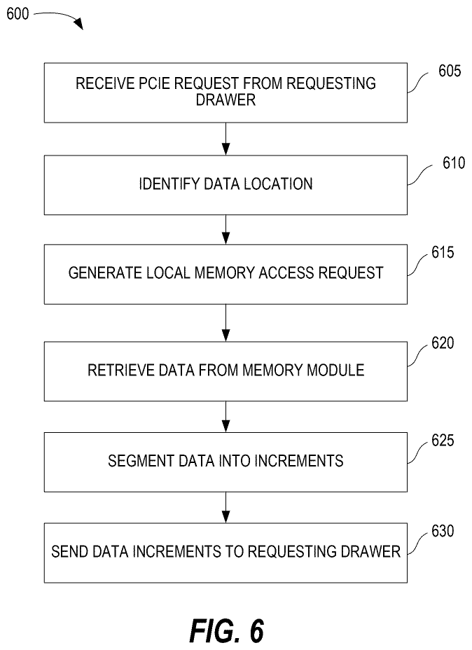

FIG. 6 depicts an example method 600 of data retrieval by a PBU after receiving a PCIe request from a remote drawer, according to some embodiments of the present disclosure. In some embodiments, the PBU may be one or more computer devices or systems configured to manage memory access requests, such as the computer 101 as illustrated in FIG. 1, the PBUs 235, 260, and 285 as illustrated in FIG. 2, the PBUs 235 and 260 as illustrated in FIG. 3, or the PBU 900 as illustrated in FIG. 9.

At block 605, a PBU (e.g., 260 of FIG. 3) receives a PCIe request (e.g., 310 of FIG. 3) from a remote drawer (e.g., 205 of FIG. 3). The PCIe request may include the target address and the instructions for either retrieving or writing data.

At block 610, the PBU checks the target address in the PCIe request to identify the specific memory module (e.g., 275-2 of FIG. 3) within its local memory array that stores the requested data (for a read request) or where the new data should be written (for a write request).

At block 615, the PBU generates a local memory access request (e.g., 325 of FIG. 3) to retrieve the data from the identified memory module (e.g., 275-2 of FIG. 3) (for a read request) or write the new data to the memory module (for a write request).

At block 620, the PBU retrieves the data (e.g., 315 of FIG. 3) from the memory module. The data may correspond to the target address specified in the PCIe request.

At block 625, the PBU segments the data into smaller increments (e.g., 256 bytes each) (e.g., 335 of FIG. 3) to comply with the interconnect protocol and hardware limitations for transmitting data.

At block 630, the PBU transmits the segmented data increments (e.g., 335 of FIG. 3) back to the requesting drawer (e.g., 205 of FIG. 3) using the interconnect. The increments may be sent sequentially until the entire block of data (e.g., 4 KB data block) has been transmitted and reassembled by the PBU in the requesting drawer.

In embodiments where the I/O request is a write request, the operations at blocks 620, 625 and 630 may be skipped. Instead, the PBU may buffer and reassemble the new data from the requesting drawer, and write the data into the identified memory module.

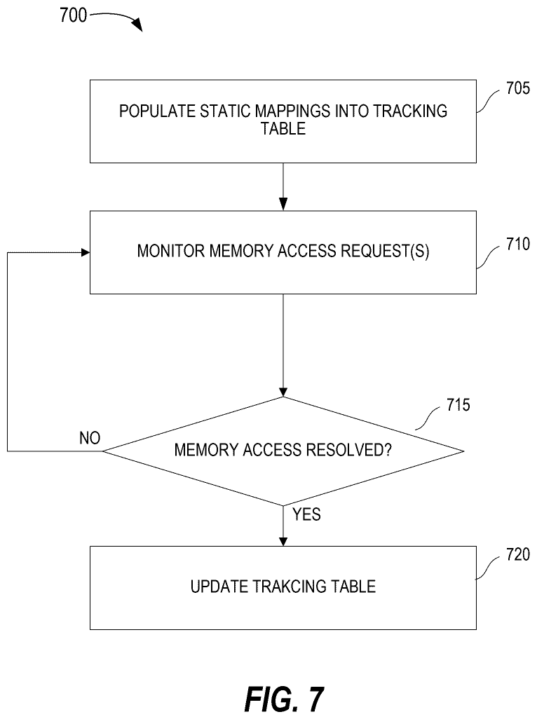

FIG. 7 depicts an example method 700 for generating and updating a tracking table with static and dynamic data, according to some embodiments of the present disclosure. In some embodiments, the example method 700 may be one or more computer devices or systems, such as the computer 101 as illustrated in FIG. 1, the PBUs 235, 260, and 285 as illustrated in FIG. 2, the PBUs 235 and 260 as illustrated in FIG. 3, or the PBU 900 as illustrated in FIG. 9.

At 705, a PBU initializes the tracking table (e.g., 400 of FIG. 4) with static information, such as static allocated address mappings and their corresponding page size, I/O domain, and target drawer.

At block 710, the PBU monitors each incoming memory access request and checks the tracking table for matching entries. In some embodiments, the request may be received from one or more I/O devices that are either connected to or physically located within the same drawer as the PBU.

At block 715, the PBU determines whether the memory access request been resolved. A read request is considered resolved when the data has been successfully retrieved from either local or remote memory, and a write request is considered resolved when the data has been successfully stared within the specified memory module in either local or remote memory. If the request is resolved, the method 700 proceeds to block 720, where the PBU updates the tracking table with new information, such as the memory location, any changes to the address range, or I/O domain information if a new requesting device was found. If the request is not resolved, this may indicate an error in the data read or write operations. In this configuration, the method 700 may return to block 710, where the PBU continues monitoring the process and keeps the tracking table unchanged until the issue is resolved. Error handling mechanisms, such as retries or error loggings, may be triggered, but no updates to the tracking table may be made until the data is successfully accessed or stored.

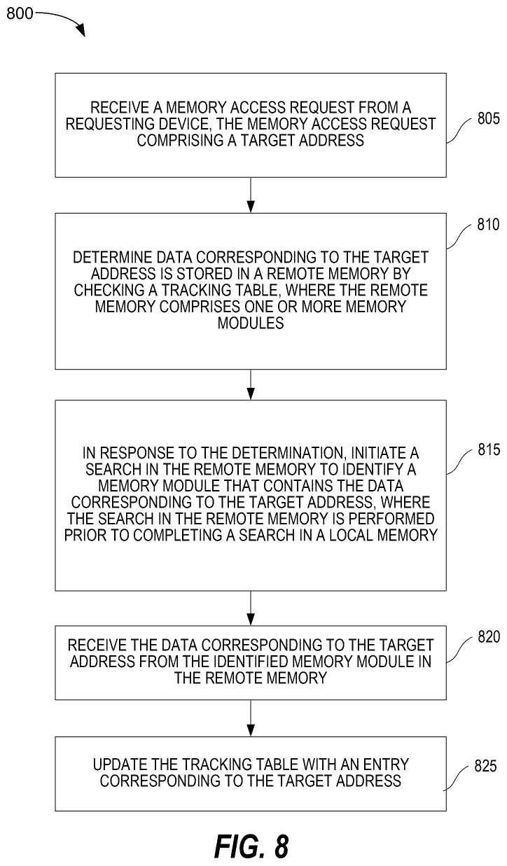

FIG. 8 is a flow diagram depicting an example method 800 for data retrieval and table update, according to some embodiments of the present disclosure.

At block 805, a computer device (e.g., PBU 235 of FIG. 3) receives a memory access request (e.g., I/O request 305 of FIG. 3) from a requesting device (e.g., I/O domain 240 of FIG. 3), the memory access comprising a target address.

At block 810, the computer device determines that data corresponding to the target address is stored in a remote memory (e.g., 270 or 295 of FIG. 2) by checking a tracking table (e.g., 400 of FIG. 4), where the remote memory comprises one or more memory modules (e.g., 275-1 or 295-1 of FIG. 2).

At block 815, in response to the determination, the computer device initiates a search in the remote memory to identify a memory module that contains the data corresponding to the target address, where the search in the remote memory is performed prior to completing a search in a local memory (e.g., 245 of FIG. 2).

At block 820, the computer device receives the data (e.g., 315 of FIG. 3) corresponding to the target address from the identified memory module in the remote memory.

At block 825, the computer device updates the tracking table with an entry corresponding to the target address.

In some embodiments, the computer device may further buffer the data from the remote memory, and send the data to the requesting device.

In some embodiments, the computer device may receive the data in increments via an interconnect, each increment having a defined size, where the defined size is a fraction of a total block size of the data.

In some embodiments, the computer device may receive a second memory access request from a second requesting device, the second memory access request comprising a second target address. The computer device may determine that data corresponding to the second target address is stored in the local memory (e.g., 245 of FIG. 2) by checking the tracking table, where the local memory comprises one or more memory modules. In response to the determination, the computer device may initiate a search in the local memory to identify a memory module that contains the data corresponding to the second target address. The computer device may receive the data corresponding to the second target address from the identified memory module in the remote memory, update the tracking table with an entry corresponding to the second target address, and send the data corresponding to the second target address to the second requesting device.

In some embodiments, to determine that the data corresponding to the target address is stored in the remote memory, the computer device may identify an entry corresponding to the target address exists in the tracking table, and determining the data corresponding to the target address is stored in the remote memory based on the entry.

In some embodiments, the computer device may receive a second memory access request from a second requesting device, the second memory access request comprising a second target address. The computer device may that there is no entry corresponding to the second target address in the tracking table. In response to the confirmation, the computer device may initiate a search in the local memory, wherein the local memory comprises one or more memory modules.

In some embodiments, the computer device may determine that a memory module in the local memory contains data corresponding to the second target address, receive the data corresponding to the second target address from the identified memory module in the local memory, update the tracking table with an entry corresponding to the second target address, and send the data corresponding to the second target address to the second requesting device.

In some embodiments, the computer device may determine that no memory module in the local memory contains data corresponding to the second target address. In response to the determination, the computer device may imitate a remote search in the remote memory, identify that a memory module in the remote memory contains the data corresponding to the second target address, receive the data corresponding to the second target address from the identified memory module in the remote memory, update the tracking table with an entry corresponding to the second target address, and send the data corresponding to the second target address to the second requesting device.

In some embodiments, the memory access request comprises a write operation, and the computer device may receive new data from the requesting device, and send the new data to the local memory or the remote memory based on the target address.

In some embodiments, the computer device may detect an error during the process of receiving the data corresponding to the target address from the identified memory module in the remote memory, and initiate an error handling process. The error handling process may include at least one of retrying to fetch the data from the remote memory, reporting the error to the requesting device, or including the error into a diagnostic log.

In some embodiments, the tracking table may comprise one or more parameters, and the one or more parameters may be selected from the group consisting of input/output domain identifier, address range, page size, local access indicator, remote access indicator, static allocation indicator, dynamic allocation indicator, and target drawer identifier. In some embodiments, the tracking table may be constructed using predefined address mappings and updated by tracking one or more memory access requests processed by a memory management unit.

FIG. 9 depicts an example PBU 900 configured to perform various aspects of the present disclosure, according to some embodiments of the present disclosure. In some embodiments, the example PBU may correspond to the computer 101 as illustrated in FIG. 1, the PBUs 235, 260, and 285 as illustrated in FIG. 2, or the PBUs 235 and 260 as illustrated in FIG. 3.

As depicted, the example PBU includes a request/response interface 930, a memory access interface 940, an address translation unit (ATU) 905, a table construction unit 910, a memory location prediction unit 915, a data buffer unit 920, and a data segment/aggregation unit 925.

In some embodiments, the request/response interface 930 may be configured to handle the communication between the PBU and the requesting device (e.g., I/O domain 240 of FIG. 2). The request/response interface 930 may receive the I/O request and forward it internally to other units within the PBU for processing. After data is received, the request/response interface 930 may send the response back to the requesting device.

In some embodiments, the memory access interface 940 may manage interactions between the PBU and memory access controller 945. The memory access interface 940 may direct requests to the memory access controller (e.g., 240-1 of FIG. 2) when the data is determined to be available in local memory, or the memory access interface 940 may route the request to one or more remote drawers (via the interconnect) when the data is determined to be available in remote memory.

In some embodiments, the address translation unit (ATU) 905 may be configured to translate a virtual address (used by software) into a physical address (used by hardware). In some embodiments, the table construction unit 910 may be designed for building and updating the tracking table that records the historical memory access patterns. In some embodiments, the memory location prediction unit 915 may work in conjunction with the tracking table to predict where the requested data is stored. If the requested data is saved locally, the memory location prediction unit 915 may initiate the search within local memory. If the requested data is saved in a remote drawer, the memory location prediction unit 915 may instruct to bypass the local search and directly access the remote drawer. In some embodiments, the data buffer unit 920 may manage to buffer data during the process of receiving the data from local or remote memory, especially when there are latency differences in cross-drawer communication. In some embodiments, the data segment/aggregation unit 925 may segment data that needs to be transmitted via the interconnect to a remote drawer. In some embodiment, when receiving data in segments (e.g., 256-byte increments) from a remote drawer, the PBU may aggregate the segments into a complete block (e.g., a 4K block) before forwarding the data to a requesting device.

While the foregoing is directed to embodiments of the present disclosure, other and further embodiments of the disclosure may be devised without departing from the basic scope thereof, and the scope thereof is determined by the claims that follow.

1. A computer-implemented method, comprising:
receiving a memory access request from a requesting device, the memory access request comprising a target address for data stored in a distributed memory system, the distributed memory system comprising a plurality of drawers, each drawer comprising a respective memory;
determining that data corresponding to the target address is stored in a remote memory by checking a tracking table, wherein the remote memory belongs to one of the plurality of drawers and comprises one or more memory modules, and the tracking table comprises address information across the plurality of drawers within the distributed memory system;
in response to the determination, initiating a search in the remote memory to identify a memory module that comprises the data corresponding to the target address, wherein the search in the remote memory is performed prior to completing a search in a local memory;
receiving the data corresponding to the target address from the identified memory module in the remote memory; and
updating the tracking table with an entry corresponding to the target address.

2. The computer-implemented method of claim 1, further comprising:
buffering the data from the remote memory; and
sending the data to the requesting device.

3. The computer-implemented method of claim 1, wherein receiving the data corresponding to the target address from the identified memory module in the remote memory comprises receiving the data in increments via an interconnect, each increment having a defined size, wherein the defined size is a fraction of a total block size of the data.

4. The computer-implemented method of claim 1, further comprising:
receiving a second memory access request from a second requesting device, the second memory access request comprising a second target address;
determining that data corresponding to the second target address is stored in the local memory by checking the tracking table, wherein the local memory belongs to one of the plurality of drawers and comprises one or more memory modules;
in response to the determination, initiating a search in the local memory to identify a memory module that comprises the data corresponding to the second target address;
receiving the data corresponding to the second target address from the identified memory module in the local memory;
updating the tracking table with an entry corresponding to the second target address; and
sending the data corresponding to the second target address to the second requesting device.

5. The computer-implemented method of claim 1, wherein determining that the data corresponding to the target address is stored in the remote memory by checking the tracking table comprises:
identifying an entry corresponding to the target address exists in the tracking table; and
determining that the data corresponding to the target address is stored in the remote memory based on the entry.

6. The computer-implemented method of claim 1, further comprising:
receiving a second memory access request from a second requesting device, the second memory access request comprising a second target address;
confirming that there is no entry corresponding to the second target address in the tracking table; and
in response to the confirmation, initiating a search in the local memory, wherein the local memory comprises one or more memory modules.

7. The computer-implemented method of claim 6, further comprising:
determining that a memory module in the local memory comprises data corresponding to the second target address;
receiving the data corresponding to the second target address from the identified memory module in the local memory;
updating the tracking table with an entry corresponding to the second target address; and
sending the data corresponding to the second target address to the second requesting device.

8. The computer-implemented method of claim 6, further comprising:
determining that no memory module in the local memory comprises data corresponding to the second target address;
in response to the determination, initiating a remote search in the remote memory;
identifying that a memory module in the remote memory comprises the data corresponding to the second target address;
receiving the data corresponding to the second target address from the identified memory module in the remote memory;
updating the tracking table with an entry corresponding to the second target address; and
sending the data corresponding to the second target address to the second requesting device.

9. The computer-implemented method of claim 1, wherein the memory access request comprises a write operation, the method further comprising:
receiving new data from the requesting device; and
send the new data to the local memory or the remote memory based on the target address.

10. The computer-implemented method of claim 1, further comprising:
detecting an error during the process of receiving the data corresponding to the target address from the identified memory module in the remote memory; and
initiating an error handling process, comprising at least one of:
retrying to fetch the data from the remote memory;
reporting the error to the requesting device; or
including the error into a diagnostic log.

11. The computer-implemented method of claim 1, wherein the tracking table comprises one or more parameters, and wherein the one or more parameters are selected from the group consisting of input/output domain identifier, address range, page size, local access indicator, remote access indicator, static allocation indicator, dynamic allocation indicator, and target drawer identifier.

12. The computer-implemented method of claim 1, wherein the tracking table is constructed using predefined address mappings and updated by tracking one or more memory access requests processed by a memory management unit.

13. A system, comprising:
one or more memories collectively containing one or more programs;
one or more processors, wherein the one or more processors are configured to, individually or collectively, perform an operation comprising:
receiving a memory access request from a requesting device, the memory access request comprising a target address for data stored in a distributed memory system, the distributed memory system comprising a plurality of drawers, each drawer comprising a respective memory;
determining that data corresponding to the target address is stored in a remote memory by checking a tracking table, wherein the remote memory belongs to one of the plurality of drawers and comprises one or more memory modules, and the tracking table comprises address information across the plurality of drawers within the distributed memory system;
in response to the determination, initiating a search in the remote memory to identify a memory module that comprises the data corresponding to the target address, wherein the search in the remote memory is performed prior to completing a search in a local memory;
receiving the data corresponding to the target address from the identified memory module in the remote memory; and
updating the tracking table with an entry corresponding to the target address.

14. The system of claim 13, wherein the operation further comprises:
buffering the data fetched from the remote memory; and
sending the data to the requesting device.

15. The system of claim 13, wherein receiving the data corresponding to the target address from the identified memory module in the remote memory comprises receiving the data in increments via an interconnect, each increment having a defined size, wherein the defined size is a fraction of a total block size of the data.

16. The system of claim 13, wherein the operation further comprises:
receiving a second memory access request from a second requesting device, the second memory access request comprising a second target address;
determining that data corresponding to the second target address is stored in the local memory by checking the tracking table, wherein the local memory belongs to one of the plurality of drawers and comprises one or more memory modules;
in response to the determination, initiating a search in the local memory to identify a memory module that comprises the data corresponding to the second target address;
receiving the data corresponding to the second target address from the identified memory module in the local memory;
updating the tracking table with an entry corresponding to the second target address; and
sending the data corresponding to the second target address to the second requesting device.

17. The system of claim 13, wherein determining that the data corresponding to the target address is stored in the remote memory by checking the tracking table comprises:
identifying an entry corresponding to the target address exists in the tracking table; and
determining that the data corresponding to the target address is stored in the remote memory based on the entry.

18. The system of claim 13, wherein the operation further comprises:
detecting an error during the process of receiving the data corresponding to the target address from the identified memory module in the remote memory; and
initiating an error handling process, comprising at least one of:
retrying to fetch the data from the remote memory;
reporting the error to the requesting device; or
including the error into a diagnostic log.

19. The system of claim 13, wherein the tracking table comprises one or more parameters, and wherein the one or more parameters are selected from the group consisting of input/output domain identifier, address range, page size, local access indicator, remote access indicator, static allocation indicator, dynamic allocation indicator, and target drawer identifier.

20. One or more computer-readable media containing, in any combination, computer program code that, when executed by operation of a computer system, performs operations comprising:
receiving a memory access request from a requesting device, the memory access request comprising a target address for data stored in a distributed memory system, the distributed memory system comprising a plurality of drawers, each drawer comprising a respective memory;
determining that data corresponding to the target address is stored in a remote memory by checking a tracking table, wherein the remote memory belongs to one of the plurality of drawers and comprises one or more memory modules, and the tracking table comprises address information across the plurality of drawers within the distributed memory system;
in response to the determination, initiating a search in the remote memory to identify a memory module that comprises the data corresponding to the target address, wherein the search in the remote memory is performed prior to completing a search in a local memory;
receiving the data corresponding to the target address from the identified memory module in the remote memory; and
updating the tracking table with an entry corresponding to the target address.
